(19) United States
(12) Patent Application Publication
(10) Pub. No.: US 2017/0039528 A1
(43) Pub. Date: Feb. 9, 2017

(54) Method and System for Sharing Digital Content

(71) Applicant: Jared Coby Becker, Cypress, TX (US)

(72) Inventor: Jared Coby Becker, Cypress, TX (US)

(21) Appl. No.: 14/821,773

(22) Filed: Aug. 9, 2015

(51) Int. Cl. G06Q 10/10; G06Q 50/00

(52) U.S. Cl. CPC G06Q 10/1095; G06Q 50/01

(57) ABSTRACT

An event generation system includes a network interface and computer processor. The network interface is configured to receive an event generation request from a remote client device. The computer processor is configured to generate events in response to the event generation request by generating an event associated with the event generation request comprising a date and a location, causing the event to be communicated via the network interface to one or more invited participants, determining that a current date matches the date associated with the event, and initiating a database for storing one or more electronic photographs associated with the event. In response to determining that the current date matches the date associated with the event, the computer processor authenticates the one or more invited participants upon a determination that one or more mobile devices associated with each invited participant is located at or near the location of the event.

### TECHNICAL FIELD OF THE PRESENT DISCLOSURE

The technical field of the present disclosure relates generally to digital content, and, more particularly, to systems and methods for sharing digital content using social media.

### BACKGROUND

The present disclosure provides methods and systems to bring about change to the process of sharing digital content associated with social events. For example, this disclosure provides advantages associated with sharing digital content associated with a particular event. Utilizing the teachings of the present disclosure, social media users may be able to create an event associated with a particular date, time, and/or location. Social media members attending the event may be able to efficiently share experiences, content, and impressions associated with the event to other social media users at the event.

### SUMMARY OF THE PRESENT DISCLOSURE

According to one embodiment, a method includes generating, by a computer processor, an event comprising a date and a location and communicating, via one or more network interfaces, the event to one or more invited participants. The method also includes determining, via the computer processor, that a current date matches the date associated with the event and initiating a database for storing one or more digital contents associated with the event. In response to determining that the current date matches the date associated with the event, the method includes activating the database, authenticating the one or more invited participants upon a determination that one or more mobile devices associated with each invited participant is located at or near the location of the event, and enabling transmission of a plurality of digital contents to the activated database from each one or more authenticated invited participants.

According to another embodiment, an event generation system includes a network interface and a computer processor. The network interface is configured to receive an event generation request from a remote client device. The computer processor is configured to generate events in response to the event generation request by generating an event associated with the event generation request comprising a date and a location, causing the event to be communicated via the network interface to one or more invited participants, determining that a current date matches the date associated with the event, and initiating a database for storing one or more digital contents associated with the event. In response to determining that the current date matches the date associated with the event the computer processor is configured to activate the database, authenticate the one or more invited participants upon a determination that one or more mobile devices associated with each invited participant is located at or near the location of the event, and enable transmission of a plurality of digital contents to the activated database from each one or more authenticated invited participants.

According to another embodiment, a network includes a first network interface operable to receive an event generation request from a remote client device and a second network interface operable to transmit the event generation to a remotely coupled event generation server. The event generation server is configured to generate, by a computer processor, an event comprising a date and a location, communicate, via one or more network interfaces, the event to one or more invited participants, determine, via the computer processor, that a current date matches the date associated with the event, initiate a database for storing one or more digital contents associated with the event. The computer processor is further configured to, in response to determining that the current date matches the date associated with the event, activate the database, authenticate the one or more invited participants upon a determination that one or more mobile devices associated with each invited participant is located at or near the location of the event, and enable transmission of a plurality of digital contents to the activated database from each one or more authenticated invited participants.

Embodiments of the present disclosure may provide a number of technical advantages. For example, a technical advantage may include the ability to more efficiently share digital content between electronic devices associated with an event at a particular time and/or location. Associating devices and/or users with particular events may also provide technological advantages by enabling the selective sharing of digital content based on whether the user was in attendance at the particular event. One or more attendees of the event may be capable of selectively sharing digital content with others not in attendance with the event. For example event organizers may be able to select whether social media users at the event may share photographs to an event web page, thereby allowing public event to generate much more digital content and wider social media proliferation as compared to an event that used more traditional methods of content sharing. On the other hand, privacy settings may enhance the ability to privately share digital content associated with more private events and gatherings while avoiding the proliferation of digital content associated with the event to non-attendees. For example, one or more privacy settings associated with the event may determine a level that sharing is allowed by attendees with non-attendees. For example, privacy settings for the event may disallow the sharing of digital content taken at the event on public social media platforms and/or may limit the sharing of digital content to friends and acquaintances of attendees at the event. Such privacy controls thereby allow for greater proliferation of digital content or lesser proliferation of digital content, depending on the goals of the event organizers and the type of event that is desired.

While specific advantages have been enumerated above, various embodiments may include, all, some, or none of the enumerated advantages. Additionally, other technical advantages may become readily apparent to one of ordinary skill in the art after review of the following figures, description, and claims.

### BRIEF DESCRIPTION OF THE DRAWINGS

For a more complete understanding of the present invention and its advantages, reference is now made to the following description, taken in conjunction with the accompanying drawings, in which like reference numbers indicate like reference numbers, and wherein:

FIG. 1 is a block diagram illustrating a system for sharing digital content;

FIG. 2 is a block diagram illustrating an apparatus for sharing digital content; and

FIG. 3 is a flowchart illustrating a method for sharing digital content.

### DETAILED DESCRIPTION OF EXAMPLE EMBODIMENTS

Shared experiences are one of the most effective ways to improve relationships and build the emotional bond between individuals. For those who have experienced a shared experience with another, the positive association of the event with those in attendance can build lasting relationships and enhance friendships. Recently, the advent of social media has provided users with a platform to share experiences with others via recorded digital content. For example, users may share electronic photographs, images, or videos with others that document the activities, desires, experiences, travels, and events that user has experienced. This process, however, allows users to share digital content regardless of whether others participated in those experiences or not. For joint participants in those experiences using existing methods of digital content sharing, the recorded digital content must be experienced in the same manner as non-participants using the same shared social media platforms. Moreover, there exists a need to be able to share digital content with other participants of an event in real-time, as the event is transpiring.

The present disclosure recognizes that an opportunity exists to enhance the shared experiences of joint participants of an event through improved methods and systems for digital content sharing. Utilizing the teachings of the present disclosure, various improvements and changes may be made to the process of sharing photos from social events from users of mobile devices. In particular, the present disclosure provides systems and methods for generating events associated with a particular date, time, and/or location. In some embodiments, sharing of digital content to a shared media platform may be restricted to users who are genuinely in attendance at the event.

The present disclosure also recognizes that particular events may be appropriate for a wide social media audience, and the event creator may accordingly allow the digital content associated with that event to be shared to the general public (or some appropriate subset thereof). For example, public events such as parades, tournaments, public gatherings, or sporting events may desire the shared experiences to be shared with a wide audience, such as those who may be experiencing the event remotely via television, the web, or other broadcast reception device. To the contrary, participants in intimate gatherings such as private parties and gatherings may desire to share digital content associated with the event with other participants of the event, but with no one else, or only with a limited number of other friends and/or family. Accordingly, this disclosure provides systems and methods for controlling the proliferation of digital content to those whom the event organizers desire.

Existing methods for sharing digital content associated with particular events suffer from various inefficiencies. As described herein, an event may refer to a particular time, date, and/or location associated with a particular social event, party, gathering, activity, happening, or similar activity. For example, while social media users may have the ability to share photographs and other media, that media is only associated with particular events to the extent that the sharer identifies the content appropriately. Even then, the labels that a user may append to that event will not necessarily be associated with other content that another user may share that is associated with that same event. Accordingly, a need exists for users that have shared experiences to efficiently share digital content that those users may capture as mementos and/or records of that event. Accordingly, the teachings of the present disclosure allow the creation of a social event which may allow the creator of the event, as well as other attendees of said event, to quickly and easily compile all digital content into a shared medium. In particular embodiments, a user may create and sponsor an “event” associated with a particular time and/or location. That sponsor may invite others to the event. In particular embodiments, the sponsor may specify a location at which the event is expected to take place. The invitation may authorize the invitee to attend the event and/or share content that the invitee may capture at the event. If the invited party accepts the invitation, then an event may be calendared by that party using an appropriate calendaring tool. Once the date and time associated with the event arrives, the invited user may be allowed to upload digital content associated with the event if the user is determined to be at the location of the event and has the appropriate permissions. Digital content associated with the event may be shared by others in attendance to the event and/or shared to other associates of attendees through other social media platforms. Thus, according to the teachings of the present disclosure, the shared experiences of participants in a common event may be enhanced through social media. Likewise, by centralizing the digital content associated with an event, the ability for non-participants to experience the shared event may also be enhanced.

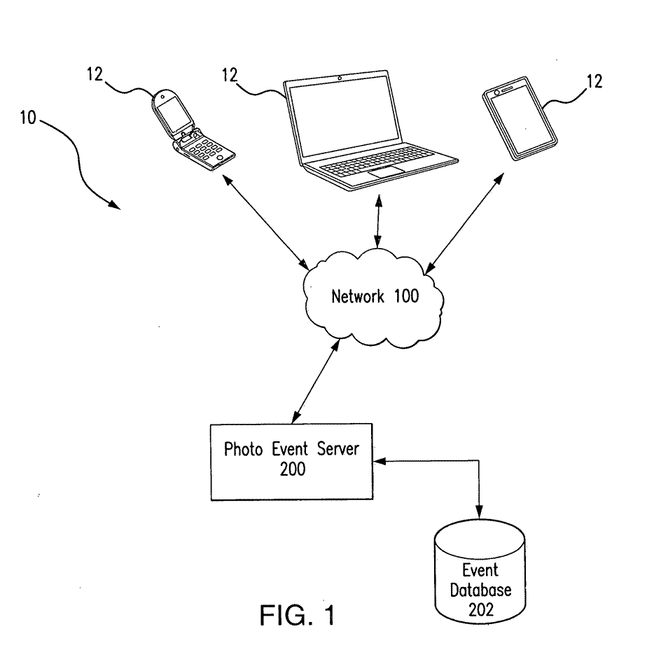

FIG. 1 is a block diagram illustrating a system 10 for sharing digital content. System 10 includes various client devices 12, network 100, digital content server 200, and event database 202. In general, system 10 allows client devices 12 to share digital content associated with particular events, such as electronic photographs, videos, or other digital content with other client devices 12 via digital content server 200. Digital content server 200 may administer and control sharing of digital content by organizing various events associated with particular times and locations, and restricting access to sharing content associated with those events to users authorized to attend the events and/or users that are actually located at the geographic locale of the event. Digital content may be stored on client devices 12 and/or by event database 202 and may be shared with various client devices 12 through a graphical user interface. Notably, while the uploading of digital content associated with the event may be restricted to users actually in attendance, digital content server 200 may include the ability to share content of the event in real time and/or after the event transpires to others not in attendance, such as friends and acquaintances of attendees of the event. Whether content is shared in real time and/or after the event may be controlled by one or more configurable settings controlled by the creator of the event (or by the attendees). Additionally, one or more privacy settings may control the extent to which non-attendees may access content associated with the event.

Client 12 may represent any appropriate client device logic capable of creating and/or transmitting digital content to digital content server 200 via network 100. For example, client 12 may represent a smart phone, tablet, laptop, or other mobile device capable of connecting wirelessly to network 100. Client 12 may include a digital camera, video recorder capable of capturing digital content such as electronic photographs or video. It should be noted, however, that client 12 need not necessarily include a camera. Client 12 may include appropriate location finding components, including appropriate hardware, software, and communication components configured to determine and/or receive a geographic location of client 12. For example, client 12 may include a global positioning satellite (GPS) transponder capable of providing geographic location information comprising the latitude and longitude of client 12. In example embodiments, client 12 may, in some embodiment may represent a tablet pc, iPhone, android device, or other equivalent mobile device. In some embodiments client 12 may integral with a camera or appropriate image capturing device. In some embodiments, a camera may be provided separately. In particular embodiments, client 12 may include appropriate client application software to allow a user to request digital content server 200 to generate events according to various user configurable settings, such as date, location, invitees, privacy settings associated with the event, and level of sharing allowed. Some, none, or all of this information may be included an event generation request that may be transmitted to digital content server 200. In some embodiments, the client application software may include appropriate mechanisms to restrict access to a locally integrated camera of device 12 during activated events. For example, once client 12 has reached the location of a particular activated event, the client application software may be capable of requiring the integrated camera to be used within the confines of the content generation application, which enforces the content sharing policies associated with the particular event.

Network 100 represents any appropriate combination of hardware software and controlling logic operable to communicate information between client 12 and digital content server 200. In some embodiments, network 100 may represent one or more of a cellular network, a local area network, a Wide Area Network (WAN), a Metropolitan Area Network (MAN), a WI-FI network, the Internet or any other appropriate network to communicate information between wired and or wireless devices. Network 100 may include any appropriate combination and number of wired and/or wireless components. Network 100 may include any appropriate combination and number of hubs, switches, routers, or other appropriate devices capable of connecting client 12 to each other and or digital content server 200. In some embodiments, client 12 may represent a mobility device capable of communicating with network 100 wirelessly.

Digital content server 200 represents any appropriate combination of hardware, software, and controlling logic operable to administer the generation and/or creation of digital content events. Digital content server 200 may receive requests to generate events from one or more clients 12. Digital content server 200 may generate and control access to shared content events. Digital content server 200 may include appropriate logic to determine when to activate a particular event, based on a received time and/or date of the event. Digital content server 200 may also create and/or maintain a list of invited clients 12 that are authorized to upload digital content associated with the event. In some embodiments, digital content server 200 may transmit event invitations, track RSVPs, and/or maintain lists of clients 12 who have accepted invitations to a shared content event. In some embodiments, however, clients 12 need not be invited to an event so long as client 12 is located at the geographic location of the event at the appropriate time. Whether clients 12 must be invited to attend an event may, in some embodiments, be a configurable event setting determined by the originator of the event (and/or attendees with the appropriate permissions to change event settings). Digital content server 200 may also include appropriate components to determine an appropriate time to activate content sharing event. Digital content server 200 may, in some embodiments, be configured to maintain a geographic location associated with the event. Digital content server may, in some embodiments, store privacy and/or sharing settings associated with the event. All, some, or none of these settings may be based on information received in an event generation request from client 12 and/or may be based on other user configurable data received from the originator of the event. Digital content server 200 may also include appropriate interfaces and/or logic to receive geographic location information sufficient to obtain and/or provide the geographic location of a particular client 12 requesting access to event database 202. For example, digital content server 200 may be capable of determining receiving the identity of client 12 based on information received from client 12. Digital content server 200 may capable of transmitting a request for location information from one more location servers by providing information identifying client 12 to said location servers. Location servers may respond by providing information providing the geographic location of client 12 to digital content server 200.

Digital content server 200 may store various rules and/or authorization conditions that control the access and/or upload capabilities of various clients 12 to particular shared content events. Some, none, or all of these rules and/or authorization conditions may be based on user configurable settings received from an event originator. For example, digital content server 200 may include various rules and/or authorization conditions to control the ability of clients 12 to upload digital content to event database 202 and/or to determine whether clients 12 are authorized to access digital content stored by event database 202. In some embodiments, digital content server 200 may restrict upload capabilities for a particular shared content event to clients 12 whose geographic location has been authenticated and/or matches the particular vicinity associated with a shared content event. Digital content server 200 may, upon activating a particular event, may allow access to client 12 based on a determination that client 12 is located at a particular location associated with a particular event. Upon determining that client 12 is located at an activated event, event server 200 may allow the uploading digital content to event database 200. Digital content server 200 may also store rules to determine whether clients 12 must be invited in order to submit shared digital content. Digital content server 200 may also store rules that determine who and when clients 12 may access digital content associated with a particular event.

Event database 202 represents any combination of hardware or software of controlling logic operable to receive event driven digital content from clients 12 and or digital content server 200. Data base 202 may, additionally or alternatively, provide access to various clients 12 to share, download, and/or view digital content based on one or more authentication rules stored by database 202 and or digital content server 200. Database 202 may be stored by any appropriate storage device including one or more hard drives, RAID drives, storage area networks (SANs), internal hard drive, or any other appropriate storage device accessible to digital content server 200. In various embodiments, digital content server 200 may control write and/or read access to event database 202 based on access and/or sharing rules stored by database 202 and/or server 200 associated with a particular event.

In operation, any one or more clients 12 may initiate an event via an appropriate graphical interface of client 12, such as an appropriate client application software. The event may be associated with a particular date, time, and/or place such as a specific venue and/or geographic location. For example, an event may be a party, wedding, family reunion, music concert, sporting event, birthday party. The location of the event may be specified by name and/or selected from appropriate mapping software. The location may be specified by latitude and longitude, an address, and/or a particular venue. In some embodiments, the event originator may specify an area associated with the event. For example, if the event covers a large geographic area (such as an event taking place at a beach or a park), the user may specify the geographic boundaries of the event. This may, in particular embodiments, be performed using interactive graphical components to draw a geometric shape on a particular portion of a mapping tool.

In some embodiments, the originator of the event may specify various other settings associated with the event, including whether or not the event is invitation only, a list of invited users, a privacy level of the event, a sharing level allowed for the event, and various other settings. Accordingly, the initiating client 12 may choose to identify one or more invitees of the event which may include one or more other client devices 12. Invitees may be identified in any appropriate manner. For example, the invitees may be identified by phone number, social media account, email address, or any other appropriate identifier. Accordingly, an appropriate invitation or notification of the event may be transmitted to other client devices 12 via network 100, by client 12 and/or upon generation of the event by digital content server 200. Additionally or alternatively, client 12 generating the event may choose to specify that the event is open to any member of the public and thus may choose not limit an event to a particular invitee.

Client 12 may also specify, via one or more configurable settings, a privacy level of the event. The privacy level may determine, for example, who is able to post digital content to the shared event media platform. The privacy level may determine a level of sharing allowed by attendees of the event. In some embodiments, a setting may be provided that allows an event originator to restrict the sharing of digital content to all members of the public, to invited guests only, to invited guests and friends of invited guests, or other appropriate level of sharing.

Upon generation of event, client application software on client device 12 may, in some embodiments, create an appropriate calendar entry or other appropriate reminders of an event in its internal memory or software. Appropriate reminders and notices may be provided as the date of the event approaches.

Upon initiating an event, client 12 may transmit an event generation request to digital content server 200. Upon receiving the event generation request, digital content server 200 may create an appropriate event to store within its internal memory and or database server 202. Digital content server 200, upon receiving an event request may generate an event associated with a particular time and or place specified by the initiating client 12. Digital content server 200 may associate event with various rules as determined by various user configurable settings. If the event is by invitation, digital content server 200 and/or the originator of the event may transmit invitations to the event to one or more invited guests. Additionally or alternatively, digital content server 200 may associate the event with one or more invited clients 12.

Digital content server 200 may restrict and/or disallow access to digital content database until determining that a time and/or date associated with the generated event has been reached. When a clock time and/or date reaches and/or surpasses the time and/or date associated with the event, digital content server 200 may activate the event within database 202. Digital content server 200 may also store end date and/or time associated with the event and may de-activate the ability to submit content to the event after the end date and/or time of the event has transpired.

Activation of the event may cause an activation message to be transmitted to invitees of the event via client application software on client 12. The transmission of this message may be selective and may be determined based on whether invitees are located at the geographic locale of the event. Additionally or alternatively, clients 12 wishing to access the shared media platform associated with the event may attempt to access the event through appropriate application software on client 12. In some embodiments, client application software on client 12 may receive notification of the date and/or location of the event by virtue of being invited. In some embodiments, the client application software may be configured to poll digital content server 200 for events associated with the present time and/or location of client 12. Digital content server 200 may be configured to respond to such polling by transmitting information associated with public events occurring at or near the time and/or location of client 12. Events that client 12 is eligible to attend may be displayed on a graphical user interface associated with client 12. The graphical user interface may allow a client to select an interactive display component that transmits a request to join and/or access the event. Before access to a particular digital content event is granted, digital content server 200 may receive a request from client 12 to join the event. Digital content server 200 may selectively authenticate various client 12 based for example, on determining that client 12 are invited guests and/or are located at the geographic locale associated with the event. Additionally or alternatively, digital content server may authenticate client 12 based on determining that they are invited to the event. In some embodiments, public events may be published to all or a portion of clients 12 regardless of whether clients 12 are located at the event. In some embodiments, determining that client 12 is at the event may trigger uploading and or sharing privileges to be applied to client 12, such that client 12 is authorized to share digital content while at the event and the event is active. Clients 12 located at the event may be configured to view, via the graphical user interface of the client application software, a plurality of digital content shared by other clients 12 that are also located at the event. In some embodiments, clients 12 not located at the event may also be authorized to view shared content from the plurality of clients 12 located at the event, which may depend on user privacy settings set for the event. In some embodiments, user configuration settings may allow only clients 12 at the event to view shared digital content during and after the event is active, but may allow clients not at the event to view shared digital content after the event expires (for example, immediately after the event or at some later time). Additionally or alternatively, clients 12 not at the event may be able to view shared digital content during the event as well, depending on user configurable settings. Depending on privacy settings associated with the event, digital content server 200 and/or client 12 may be configured to restrict access to digital content creation of client 12 according to the privacy settings of the event. This may include no digital content capturing at all and/or may restrict digital content capturing to be only through the client application software that communicates with digital content server 200. This may prevent unauthorized capturing of digital media and sharing through unauthorized social media platforms.

Upon determining that a client 12 is authenticated to share content, event digital content server 200 may allow uploading of digital content associated with the event to database 202 while the event is active. In some embodiments, digital content server 200 may inspect meta data associated with uploaded digital content to ensure that submitted digital content was captured at the time and or location of the event. In some embodiments, digital content server 200 may be programed to deny access to any attempts to upload content not associated with the time and location of the event.

During or after a particular event, digital content server 200 may share digital content associated with the event in any appropriate fashion. For example, digital content server 200 may selectively to share digital content associated with the event only with invitees to the event, may be programmed to share content with friends or associates of invitee, or may be programmed to share content with any members of any particular social media platform. The digital content may be organized and or grouped by the particular event after the digital content has been captured.

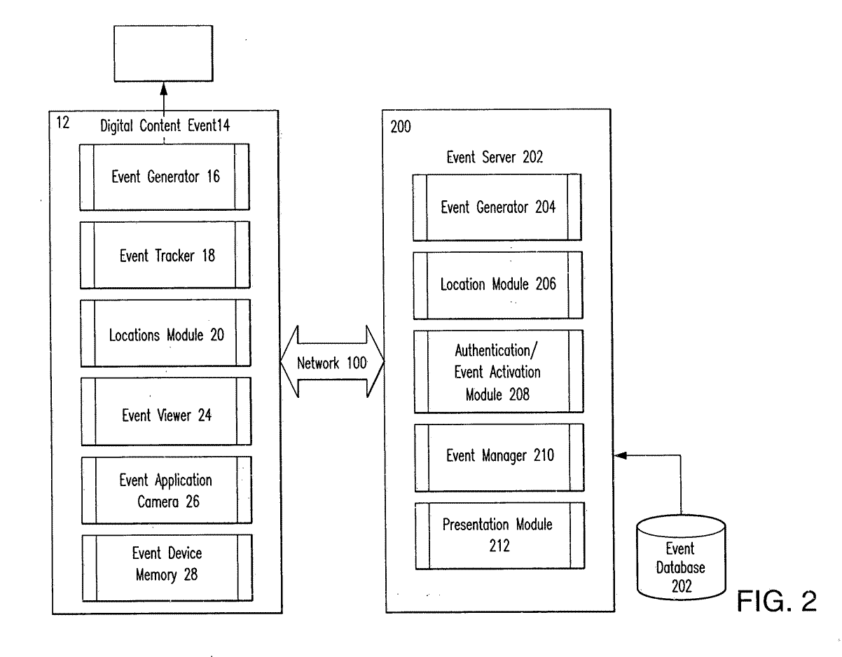

FIG. 2 is a block diagram illustrating an example system for sharing digital content. As illustrated, system 10 includes one or more devices 12. In the illustrated embodiment, device 12 includes client application software 14. The various components of client application software 14, include event generator 16, event tracker 18, location module 20, event viewer 24, event application camera 26, and device memory 28. In the illustrated embodiment, event server 200 includes event generator 204, location module 206, authentication and event activation module 208, event manager 210, presentation module 212. In general, client application software 14 allows digital content captured by camera 26 to be shared with other user devices by interacting with particular components of event server 202 via network 100.

Client application software 14 may use event generator 16 to generate particular events associated with a particular time and location. Event tracker 18 may be utilized by digital content application 14 to determine that a particular time associated with a created event has transpired. Digital content application 14 may utilize location module 20 to determine whether a particular user device 12 is at a location associated with a particular event and therefore eligible to post content to the event server 202. Event viewer may be utilized to view historical events based on determining that a user was at a particular location and time or otherwise has access to view digital content from the event.

Event server 202 may control the administration and access and generation to events associated with a particular time and location. Event server 202 may utilize event generator 204 to receive events requested for generation from user devices 12. Event server 202 may receive user location and time information to determine that they are located at a particular location associated with the event. Event generator 204 controls the creation and generation of events, including setting the various rules that may be associated with a particular event, including location, start times, end times, privacy settings, sharing settings. Location module 206 may be responsible for determining the location of a particular client 12 requesting access to a particular event, and/or may be capable of requesting that information from a remote location server. Authentication module 208 may be capable of determining if the location information associated with client 12 is appropriate for the particular event. In some embodiments authentication module 208 may be configured to enforce various rules associated with the event (such as administering the invitee list, privacy settings, and sharing settings of the event). Event activation module 208 may be responsible for activating events and/or de-activating events based on a clock time and the time associated with the event. Event activation module 208 may track time associated with an event to determine whether to activate that event and allow users to begin adding digital content for the event. Event manager 210 may be responsible for handing requests to submit content associated with a particular event, and storing digital content in event database 214. Presentation module 212 may be responsible for retrieving digital content from event database 214 upon request by an accessing client 12.

Event generator 16 comprises and appropriate combination of hardware, software and logic configured to generate events associated with a particular time and/or location. Event generator 16 may compromise all or a portion of a graphical user interface that allows creation of an event associated with a particular time and location of an event, for example event generator 16 may include an appropriate calendar tool with appropriate interactive graphical subcomponents allow a user to select a particular time for the event. Event generator 16 may present and/or access a graphical mapping tool from which a user can select an appropriate desired location. Event generator 16 may also include various selectable elements that correspond to the various invitation settings, privacy settings, and sharing settings associated with the event, as described herein. Event generator 16 may include access to appropriate wireless interfaces of client 12 to transmit an event generation request to event server 202 via network 100.

Event tracker 18 may comprise any appropriate combination of any hardware or software or controlling logic configured to determine whether appropriate conditions associated with digital content event have occurred. For example, event tracker may determine that a particular time associated with an event has occurred. Event tracker 18 may utilize appropriate calls to location module 20 to determine whether a location associated with an event has taken place. Event tracker 18 may comprise various background routines configured to run in background of user device 12. When certain conditions associated with a generated event transpire, event tracker 18 may trigger notifications on client device 12 to alert user of an impending event. Event tracker 18 also may transfer appropriate information via network 100 to digital content server 202, such as the identity and/or location of client 12, which may aid or allow event server 202 to determine client 12 is authorized to submit digital content and is at the geographic location of the event. Event tracker 18 may also receive event information from event server 202 that indicates nearby occurring or soon to occur events to client 12 that may allow client 12 to submit digital content. This functionality may be enabled, for example, by event tracker 18 periodically polling event server 202 with the location of client 12 and/or requesting event server 202 to provide nearby events. Events may be displayed (or not displayed) according to the specified preferences of the user. Additionally or alternatively, event tracker 18 may be capable of informing a user of client 12 of sharing events of interest that have occurred, are occurring, or will occur that are of interest to client 12 regardless of vicinity. These may be activities for which client 12 may not be eligible to submit content, but client 12 may be able to view and/or access shared content from one or more clients 12 actually in attendance at the event. For example, tracker 18 may store particular places or activities of interest (such as sporting events, Statue of Liberty photos, photos of particular parks, beaches, or recreational areas, etc.), or particular participants of interest (such as friends, family, or other personalities of interest such as favorite celebrities) that are specific to the user of client 12. These may be based on user-specified preferences stored by event tracker 18. When events associated with particular activities or persons of interest available, or events for which client 12 is otherwise eligible to access, event tracker 18 may inform user of client 12 of such events via an appropriate alert setting.

Location module 20 may comprise any appropriate combination of any hardware or software or controlling logic to determine location of end user device 12. For example, location module may be configured to determine location based on signals from one or more global positioning satellites (GPS). Additionally, locations module 20 may be operable to determine location based on information received from a wireless base station or other communication device. As another example, location module 20 may be configured to determine its own location based on triangulating information or signals transmitted to one or more known wireless base stations. Location module may be able to determine location based on polling an appropriate location server.

Event Viewer 24 may comprise any appropriate combination of any hardware or software or controlling logic to request viewing access to particular digital content events from event server 202. For example, event viewer 24 may utilize appropriate calls to event activation 208 via network 100 to determine if the current user device 12 has sufficient permissions to view content and if it should be granted access to the events digital content. Additionally, event viewer 24 may be configured to receive input from user device 12 that would help determine appropriate actions on digital content. Further, event viewer 24 may be presented input from user device 12 that will allow special access that does not fit in normal conditions. Digital content associated with particular events may be presented by event viewer 24 in any appropriate manner. Digital content may be presented as an album of pictures and/or thumbnails, as all or a part of a web page, or any other appropriate manner.

Event application camera 26 may comprise and appropriate combination of hardware and/or software for allowing digital content creation or editing. For example, event application camera may be granted access to event content from Authentication module 208 via network 100 in order to create or edit event digital content. Event application camera 26 may be capable of restricting local access to the hardware camera of client 12 depending on the restrictions imposed on the event by event server 202.

Event device memory 28 may comprise any appropriate combination of hardware and/or software necessary for allowing storage of event based information on user device 12. For example, event device memory 28 may store locally information pertinent to event attendance such as location, time, invitee responses. Event Device memory 28 may be used to alert the user device when qualifying events have occurred or are about to occur, such as event start arrival, successful check in or the like. Event device memory 28 may be used as temporary and/or permanent storage of digital content that is downloaded from event server 202 and/or is pending upload to event server 202. Event device memory 28 may, depending on permissions associated with the event, be configured to store local copies of shared digital content associated with a particular event.

In operation, a user of device 12 interacts with client application software 14 to initiate one or more digital events. Client application software 14 leverages the event generator 16 to gather any appropriate information required to save the event successfully. Event generator 16 provides a user interface to device 12 to gather and validate the new events location, time, invitees, and other information necessary to initiate a request to save the event created to the event server 200 via network 100. Event generator 16 may transmit an event generation request reflecting the appropriate information and settings to event server 202. Digital content server 200, upon receiving the event request creates a new entry, associated it with any invited clients 12 and saves it to the event database 202 via network 100. Event generator 16 and/or event generator 204 may also be responsible for transmitting invitations to any invited guests of the particular event.

Once an event has been generated by event generator 204, event tracker 18 may monitor appropriate information, such as date, time, and location information to determine if the conditions necessary to activate the event have occurred. These could include a check to determine if the event time has been reached; the event location is nearby the location of client 12; or other appropriate checks. Event Locations Module 20 facilitates determining the location of client 12 and pas it to the location module 206 on event server 200. Event location module 20 is used to determine if the user device 12 is at, or nearby the events required location.

Event viewer 24 displays the appropriate information to the user device 12 through communication with the presentation module 212 and the event manager 210 on the event server 200. Event Viewer 24 will make a call to the Authentication/Event Activation module 208 to via network 100 to determine the appropriate level of event visibility by the user device. These appropriate levels of visibility may include any appropriate event information before, during, or after the event has transpired such as any digital content uploaded by the user devices, event statistics including the number of users present and level of activity. Additional calls to the event manager 210 via network 100 may be made to perform administrative tasks or requests such as providing override codes to individual users for the purpose of allowing specific access to the event. Event viewer 24 also allows access to the event application camera 26 to upload photos to the event manager 210 and through to the event database 202 for storage and access.

Event application camera 26, upon being accessed, may use any appropriate technologies to capture and make edits to the desired digital content through the user device 12 and submit this digital content for catalog and storage on the Event Database 202 via network 100. Event application camera 26 and/or event viewer 24 may enforce permissions related to what content is allowed to be uploaded to digital content server 200. For example, event application camera 26 may restrict access to other locally stored media that was not taken at the particular location of the active event. In addition, event application camera 26 may be responsible for storing meta data associated with each article of digital content captured by client 12. For example, event application camera 26 may associate the identity of the user of client 12, the location where captured, and the date and times captured. This information may be accessed by event manager 210 to determine whether submitted digital content is eligible to be shared among the joint participants of the shared event.

Event device memory 28, may include any necessary memory device capable of permanently and/or temporarily storing information, such as locally captured digital content and various event settings. This information may facilitate viewing, tracking, and content capturing. This may include storage of locations, times, content until such time that the event is no longer relevant, has been changed, or has been removed.

Event server 202 may employ event generator 204 to receive event generation requests from clients 12. Event generator 204 may generate and store event information in event database 204. This information may include the date, time, location, name, place of the event. This information may also include various permissions associated with the event, such as whether the event is public or private, who may access the shared content, and who may upload shared content to the event database 202. Location module 206 may determine location information of clients 12 requesting access to submit content to an event. Location module 206 may be accessed and/or employed by event authentication and activation module 208. Event authentication and activation module 208 determines if a particular event should be activated based on the conditions for activation set by the event generator 204. For example, an event may be activated upon a determination that the date and time associated with the event has arrived, authentication and activation module 208 also may receive requests to access and/or publish shared content events from clients 12. Access to events may be granted depending on the invitee status of the client 12 and/or the privacy level of the event.

In the event that the client 12 requests to publish content to the shared event database 202, activation module 208 may determine whether rules regarding the publication of content allow client 12 to publish content. For example, rules may limit publication to attendees of the event that are actually at the geographic location of the event. Rules may additionally or alternatively limit publication to individuals with particular permissions. Thus, if the client 12 does not have the appropriate permissions, client 12 may be denied access to publish content even if client 12 is located at the particular event. Notably, the denial of the publication right to the shared content event need not be explicit. For example, the event viewer 24 of client application 14 may simply grey out or otherwise disable access to event application camera 26 if client 12 does not have appropriate permission to publish content.

In the event that client 12 requests to access content, authentication and activation module 208 may determine if client 12 has the appropriate permissions to access shared content of the event. For example, module 208 may apply a rule that all clients may access content in the event that the event setting is public. As another example, module 208 may apply a rule that a client 12a may access shared content if friends a client 12b in attendance at the event. Accordingly, module 208 will determine that client 12a may access the event if client 12a is friends with a client 12b in attendance (or a client 12b in attendance has otherwise granted permission to client 12a). Module 208 may also apply a rule that the event is private and only attendees who have been invited and/or are in attendance at the event may access the shared digital content. While specific rules are discussed, it is within the scope of present disclosure for any appropriate level of permission and/or privacy to be applied to a shared content event. Additionally or alternatively, a different level of permission and/or privacy may be applied after the event ends (for example, privacy and access settings may be relaxed if desired).

It should be noted that the discussion above is framed in the context of a request for access from client 12, access to shared content events may be accomplished in any number of appropriate ways. For example, event server 202 may determine whether client 12 is eligible to be informed of particular events in response to polling messages transmitted by event tracker 18 and/or locations module 20 that identify the location and/or event preferences of a particular client 12. Additionally or alternatively, event preference information for each client 12 may be stored in event database 202. In some embodiments, client 12 may not affirmatively be “denied” access to a particular event, but the event may simply not appear on a calendar tool or other list of available shared content events on client application server 14's graphical user interface.

After the event is activated, event manager 210 may control the submission of content and/or presentation module 212 may control access to content for authenticated clients 12. For example, event manager 210 may access 202 to submit content associated with particular events. Event manager 210 may be capable of storing additional information associated with the submitted content to facilitate and encourage shared experiences among the participants in the event. For example, event manager 210 may store identifying information regarding submitter of the content, the particular time, and particular location from which the digital content was captured. This information may be utilized by event viewer 24 to develop a timeline of activities that occurred while the event is active.

Presentation module 212 may also handle requests for access to shared content. Presentation module 212 may invoke rules stored by activation module 208 to determine if a client 12 is eligible to view shared content. Like the submission of content, the events for which client 12 is eligible to view content may be determined by permissions associated with the event (e.g., public or private), the invitee status of client 12, and/or the preferences of client 12 (e.g., the type of events or particular people the client 12 prefers to view). It should be understood that all of these permissions may be user configurable and may be particular and tailored to a specific event. Thus, a particular event may apply any appropriate level of viewing permissions and privacy settings.

After the ending time associated with the event transpires, the event may be de-activated, and the ability to submit additional content associated with the event may end and/or be phased out over time. In some embodiments, there may be a window of time after the event transpires to continue to upload new shared content, which may be restricted by meta data to digital content that was captured by event application camera 26 during the active times of the event and while at the geographic location of the event. This may allow for persons who prefer not to upload shared content during an event a convenient time to do so afterwards.

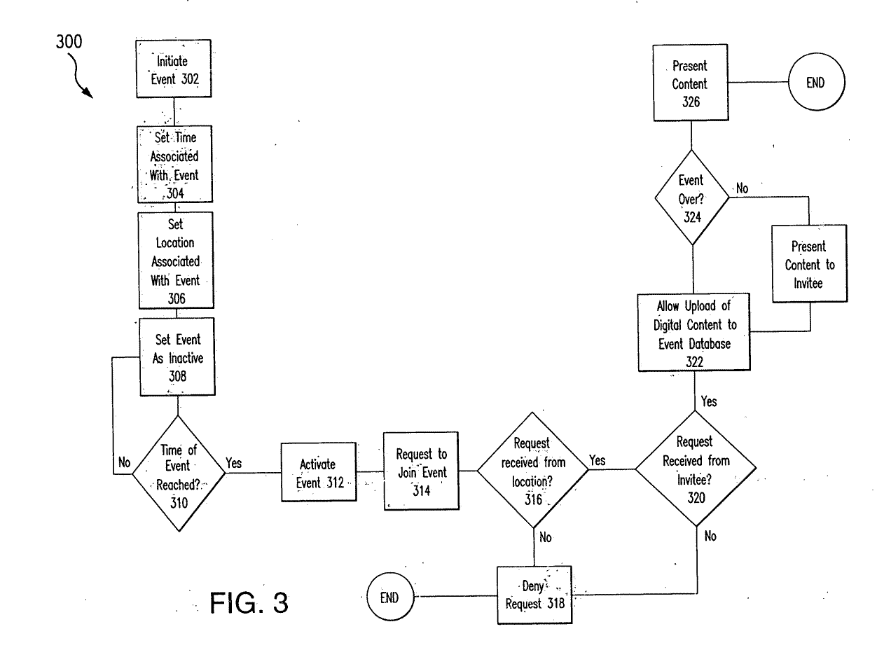

FIG. 3 displays a method 300 in order to initiate, create, and present events information from inception to completion. An event is initiated from the user device during 302. The initiate event step 302 may include any appropriate user registration, login requirements in order to begin the event creation process. This may represent a series of steps for client 12 to login and initiate a new event with digital content server 200. Step 304 includes the time and date settings for the event creation and may include an appropriate combination of dates, times, or date and time ranges. Step 306 represents the process for entering and configuring the location of the event. Step 306 may also include setting various user configurable settings associated with the event, such as privacy settings, invitees, sharing settings, and the like.

At step 308, digital content server 202 sets the event to inactive so that it will not be accessible until the appropriate requirements have been met to activate it. At step 310, the event tracking software determines to activate the event or not based on the specified time of event having been reached or not. If the condition passes then it flows to step 312 where the event is activated by digital content server 200. Step 314 represents the requests from user devices to join the recently initiated event, this can be done in an ad-hoc request or based on information gathered during the previous steps. In some embodiments, this is determined based on settings associated with the event specified in step 306.

At step 316, digital content server 200 determines whether a user device requesting access from step 314 is at the correct event location and/or is otherwise eligible to post content to the event database 202. If the device is deemed to not be at the correct location, then in step 318 the request is denied and the process is ended.

If however, the device is deemed to be at the correct location, step 320 is reached which is another decision to be made based on the user being on the invitee list. If the user is deemed to not be on this list then step 318 is reached which denies the request and ends the process. If however, the user is on the invitee list then step 322 is reached.

In step 322, the user/user device is allowed to upload digital content to the events' file store in database 202 as desired until the event is over at step 324. The event may be concluded based on the event creators specified time duration settings. If the event is not over then the digital content produced by that invitee is presented to the invitee for editing, deleting, or viewing the digital content. When the event is deemed over, step 326 is reached which allows both the invited users, as well as any other authorized viewers of the content, to view all of the content they have submitted as well as allows the event host to review all submitted content and make any edits they require.

Modifications, additions, or omissions may be made to method 300 as illustrated in the flowchart of FIG. 3. For example, digital content server 200 may be capable of creating and administering many events in parallel. Digital content server 200 may be capable of serving any number of clients 12 at once and/or in parallel according to the teachings of the present disclosure. The steps of FIG. 3 may be performed in parallel or in any suitable order. Thus, digital content server 200 may capable of be performing the disclosed method many times over in parallel and may be executing any given step with respect to one event simultaneously with any other step with respect to another event. Digital content server 200 may form a standalone program and/or may be a subcomponent of any appropriate digital content sharing program and/or social media platform. Likewise client application software 14 may form a standalone program and/or form all or a part of any other appropriate software or software components. The various modules and subcomponents described herein are described functionally and may perform overlapping functions and/or may all be performed by a single monolithic program or specialized device. The logic described herein may be embedded in any appropriate form of non-transitory media and is fully capable of performing the described functionality when executed by a computer processor. The modules and components described herein may be comprised of logic and/or may also be inclusive of any appropriate underlying hardware components. Moreover, the embodiments described with respect to the present disclosure are expected be fully combinable and suitable for use in appropriate embodiments described herein.

Although the present disclosure has been described in several embodiments, a myriad of changes and modifications may be suggested to one skilled in the art, and it is intended that the present disclosure encompass such changes and modifications as fall within the present appended claims. In addition, it is contemplated that various embodiments may be combinable and/or represent various aspects of a single embodiment.

What is claimed is:

1. A method comprising:
generating, by a computer processor, an event comprising a date and a location;
communicating, via one or more network interfaces, the event to one or more invited participants;
determining, via the computer processor, that a current date matches the date associated with the event;
initiating a database for storing one or more electronic photographs associated with the event; and
in response to determining that the current date matches the date associated with the event:
activating the database;
authenticating the one or more invited participants upon a determination that one or more mobile devices associated with each invited participant is located at or near the location of the event; and
enabling transmission of a plurality of electronic photographs to the activated database from each one or more authenticated invited participants.

2. The method of claim 1, further comprising:
sharing, via one or more interfaces, the plurality of electronic photographs from the event database with the one or more authenticated participants.

3. The method of claim 2, further comprising:
sharing, via one or more interfaces, the plurality of electronic photographs from the event with one or more other accounts associated with the one or more authenticated participants.

4. The method of claim 1, further comprising:
determining an end time associated with the event; and
upon determining that the current time matches the end time, deactivating the event database, thereby preventing additional electronic photographs from being added to the database.

5. The method of claim 1, wherein each authenticated invited participant is granted access to a website associated with the event that automatically displays each of the plurality of electronic photographs from the event.

6. The method of claim 1, wherein each of the one or more mobile devices is configured to permit transmission of an electronic photograph to the database associated with the event in response to determining that the electronic photograph was taken at the time and the location of the event.

7. The method of claim 1, wherein communicating, via one or more network interfaces, the event to one or more invited participants comprises creating a calendar entry on one or more mobile devices associated with the one or more invited participants.

8. An event generation system comprising:
a network interface, the network interface configured to receive an event generation request from a remote client device;
a computer processor configured to generate events in response to the event generation request by:
generating an event associated with the event generation request comprising a date and a location;
causing the event to be communicated via the network interface to one or more invited participants;
determining that a current date matches the date associated with the event;
initiating a database for storing one or more electronic photographs associated with the event; and
in response to determining that the current date matches the date associated with the event:
activating the database;
authenticating the one or more invited participants upon a determination that one or more mobile devices associated with each invited participant is located at or near the location of the event; and
enabling transmission of a plurality of electronic photographs to the activated database from each one or more authenticated invited participants.

9. The system of claim 8, the computer processor further configured to share, via one or more interfaces, the plurality of electronic photographs from the event database with the one or more authenticated participants.

10. The system of claim 8, the computer processor further configured to share, via one or more interfaces, the plurality of electronic photographs from the event with one or more other accounts associated with the one or more authenticated participants.

11. The system of claim 8, the computer processor further configured to determine an end time associated with the event; and upon determining that the current time matches the end time, deactivate the event database, thereby preventing additional electronic photographs from being added to the database.

12. The system of claim 8, wherein each authenticated invited participant is granted access to a website associated with the event that automatically displays each of the plurality of electronic photographs from the event.

13. The system of claim 8, wherein each of the one or more mobile devices is configured to permit transmission of an electronic photograph to the database associated with the event in response to determining that the electronic photograph was taken at the time and the location of the event.

14. The system of claim 8, wherein communicating, via one or more network interfaces, the event to one or more invited participants comprises creating a calendar entry on one or more mobile devices associated with the one or more invited participants.

15. A network comprising:
a first network interface operable to receive an event generation request from a remote client device;
a second network interface operable to transmit the event generation to a remotely coupled event generation server, the event generation server configured to:
generate, by a computer processor, an event comprising a date and a location;
communicate, via one or more network interfaces, the event to one or more invited participants;
determine, via the computer processor, that a current date matches the date associated with the event;
initiate a database for storing one or more electronic photographs associated with the event; and
in response to determining that the current date matches the date associated with the event:
activate the database;
authenticate the one or more invited participants upon a determination that one or more mobile devices associated with each invited participant is located at or near the location of the event; and
enable transmission of a plurality of electronic photographs to the activated database from each one or more authenticated invited participants.

16. The network of claim 15, the event generation server further configured to share, via one or more interfaces, the plurality of electronic photographs from the event database with the one or more authenticated participants.

17. The network of claim 15, the event generation server further configured to share, via one or more interfaces, the plurality of electronic photographs from the event with one or more other accounts associated with the one or more authenticated participants.

18. The network of claim 15, the event generation server further configured to determine an end time associated with the event; and upon determining that the current time matches the end time, deactivate the event database, thereby preventing additional electronic photographs from being added to the database.

19. The network of claim 15, wherein each authenticated invited participant is granted access to a website associated with the event that automatically displays each of the plurality of electronic photographs from the event.

20. The network of claim 15, wherein each of the one or more mobile devices is configured to permit transmission of an electronic photograph to the database associated with the event in response to determining that the electronic photograph was taken at the time and the location of the event.
